(19) United States
(12) Patent Application Publication
(10) Pub. No.: US 2012/0035929 A1
(43) Pub. Date: Feb. 9, 2012

(54) MESSAGING SYSTEM

(76) Inventors: Allan Gauld, Middlewich (GB); Sarah Elizabeth Roberts, Middlewich (GB)

(21) Appl. No.: 13/201,414

(22) PCT Filed: Feb. 9, 2010
(86) PCT No.: PCT/GB2010/050201

§ 371 Date: Oct. 25, 2011

(30) Foreign Application Priority Data
Feb. 13, 2009 (GB) 0902433.2

(51) Int. Cl. G10L 17/00

(52) U.S. Cl. 704/246; 704/E17.001

(57) ABSTRACT

The messaging system (100) comprises a message data engine (101), a message generation engine (102), and an inference analysis engine (107). The message data engine (101) is operable to identify the desired recipient of the message, analyse and deconstruct the desired message content into syllables, words or phrases as desired or as appropriate. The message or part message may then be passed to the inference engine (107) for review of the message content and context. The message may then be referred back to the requestor (111) through the interface (103) with details of the problem for remediation, or passed to the message generation engine (102) for transcription. The message generation engine (102) may apply a range of speech samples and/or speech parameters as appropriate to the input message in order to compile a representation of this message with the speaker characteristics that were requested. The message generation engine (102) is then further operable to despatch the generated message to the desired recipient's device (114) via the network (110).

The present invention relates to a messaging system and in particular, to a messaging system operable to generate and deliver to a desired recipient personalised messages from a requester.

On many occasions, people wish to send greetings to friends and loved ones, particularly if it is not convenient to meet the friend or loved one directly at that time. Traditionally, this may have been achieved by way of posting a card or letter or making a telephone call. More recently, this has also been achieved by email or text message, which whilst convenient can lack a personal touch.

It is also popular in the current age for greetings e.g. greetings cards to be celebrity themed. Such cards enable the requester to provide a recipient with a greeting endorsed by or at least in the style of a favoured celebrity of the recipient. This can make the greeting that much more special for the recipient. Unfortunately, there is little opportunity to personalise the celebrity aspect of such cards. They are also much less convenient to send than text messages or email. Furthermore, it may be difficult for the requester to ensure the greeting reaches the desired recipient at the appropriate time, if sent by post.

It is therefore an object of the present invention to provide a new messaging system that provides convenient messaging incorporating a celebrity theme but also enables a level of personalisation.

According to the present invention there is provided a messaging system comprising: a message data engine operable to receive an incoming message request, identify the intended recipient of said message, identify the intended speaker of said message, analyse and deconstruct the message content; and a message generation engine operable to generate a voiced message from the deconstructed message content by retrieving corresponding speech data relating to the intended speaker.

This therefore provides a convenient system by means of which a message voiced/presented by a desired celebrity or personality incorporating personalised content may be generated and delivered to a dashed recipient. In particular, this may allow a requestor to generate a message for delivery comprising a celebrity voice speaking, singing, rapping or otherwise voicing words substantially of the requestor's choosing.

Incoming message requests may be received directly at an input device. The messaging system may deliver generated messages directly to an output device. Additionally or alternatively, incoming message requests may be received in any suitable data format and via a connection to a suitable communication network. In a similar additional or alternative manner, the messaging system may output generated messages to a suitable communication network for delivery. Suitable communication networks may include public telephone systems, either cellular or fixed line as desired or required, internet connections, Wi-Fi networks or other data networks. The message delivery and the request receipt may occur via the same network or type of network or via different networks or types of network. In a preferred embodiment, the system is connected to a plurality of networks or types of network and may receive requests or organise message delivery via any one or more of the networks or types of network. An alternative embodiment may allow for the message request and delivery from/to the same device.

The message data engine may be operable to identify the message requester. In such circumstances, the message data engine may be connected to a suitable payment system, in order that payment is obtained from the requester for delivering and/or generating the message. The payment system may be operable to debit a requester account on the system or a requester's account with a financial services facility such as a bank or other authorized payment scheme or network provider.

The system may store details relating to the requester in a database. The message data engine may be operable to allow a requester to retrieve, delete or edit such details as desired. The message data engine may utilise the stored requester details to automatically generate part of the information required to generate a message. The system may additionally store details relating to the message content and/or intended speaker in a database.

Message requests may be input using any suitable input device operable to connect to the system via any suitable network. Suitable input devices may include, but are not limited to telephones (mobile or fixed line), personal digital assistants or similar devices, computers (portable or fixed), scanning devices, (cameras, media players/recorders, video broadcast encoding apparatus, or personal media players), games consoles, or dedicated terminals.

The messaging system may be operable to present an interface to enable recipient identity details, intended speaker details (e.g. a celebrity or personality) and message content to be input separately. The interface may present differently for different input devices. For suitably equipped input devices, the interface may present as a set of pre-recorded instructions. The requestor can respond to the instructions and input data by speaking. For suitably equipped input devices, the interface may comprise a preset display screen. The requestor may input data by means of one or more selectable menus and/or one or more text entry boxes. In the event that a requester's input device is equipped for either form of interface, the preferred form of interface may be selectable. In one preferred embodiment, the interface comprises one or more software objects or applications running on a suitable device such as a smartphone, tablet computer, personal digital assistant, media player, laptop computer or similar.

The intended speaker may be chosen by selection from a list of available speakers. The interface may optionally provide the full list or one or more categorised sub-lists to the requestor.

The message content may be input by selecting an existing message template, editing an existing message template or by creating a bespoke message. By the choice of specific templates or through the selection from a context list for bespoke message input during the input process, the intent of the message shall be defined. In the case of a bespoke message or the editing of an existing template, the message data engine may be operable to deconstruct spoken content or may be operable to deconstruct text based content as appropriate. The message data engine may deconstruct the message content into single sounds or syllables, complete or part words, complete or part phrases as appropriate.

The message data engine may be operable to pass the message, in whole or in part, to an inference engine for further analysis. The inference engine may be operable to analyse the message content and context and thereby determine whether the message is potentially defamatory or offensive. The analysis may include identifying the context in which the messages is being sent i.e. birthday greeting, commiseration or the like. This can be identified by analysing the message content or by detecting a message context or template selection prior to, during or after message content input. The inference engine may be additionally operable to analyse the message grammar and clarity. In the event that the message content is determined to be potentially defamatory or offensive, the inference engine may be operable to refer the message back to the requestor. The requestor may have the option of amending the message content for reanalysis by the inference engine.

The time of delivery of the message to the recipient may be selectable. In order to allow delivery of the message, the recipient identity details must include an address or identity for a suitable output device to receive the message. The output device may be a standalone device or may be attached to or incorporated into another device. Suitable output devices may include, but are not limited to telephones (mobile or fixed line), personal digital assistants or similar devices, computers (portable or fixed), scanning devices, cameras, media players/recorders (televisions, projection apparatus and the like (including cinema projection apparatus), CD/DVD players/recorders, digital/analogue video players/recorders, television decoder apparatus, radios, Hi-fi systems or personal media players), games consoles or dedicated terminals. Suitable output device addresses or identities may include a telephone number, instant messaging username, email address, internet protocol address or other unique identifier or similar. The format of the delivered message may be dictated by the recipient address and/or the recipient's output device. Alternatively, if possible, the desired delivery format from a list of possible delivery formats may be selectable. The message may be played or streamed over a suitable network or link, delivered in the form of a file for playback by the output device, or delivered in the form of a link to a location from where the message can be played, streamed or downloaded for later playback. The message may be provided in any audio or audio visual format suitable for delivery. In one preferred embodiment, the message may be provided in a format compatible with standard multimedia messaging services (MMS).

The speech data may comprise speech samples and/or speech parameters such as cadence, tone, excitation, inflexion, spectral characteristics, phonetic characteristics, linguistic characteristics, sound/pause duration or similar. The message may be generated by retrieving and combining together one or more speech samples of the intended speaker. Additionally or alternatively, the message may be generated in whole or in part by applying speech parameters to pre-existing speech samples. The pre-existing speech samples may be neutral speech samples or samples of the intended or another speaker. In this manner, words or phrases can be built up even if an exactly corresponding speech sample does not exist.

The messaging system may comprise a data storage unit operable to store a library of speech data provided by a plurality of speakers. Typically, the speakers may have famous or distinctive voices. In a particularly preferred embodiment, each speaker may be a celebrity, personality or the like. The speech data may comprise speech samples or speech parameters obtained by algorithmic analysis of a speaker's voice. The speech may comprise single sounds or syllables, complete or part words, complete or part phrases as appropriate. Similarly, the speech parameters may be obtained by algorithmic analysis of a speaker voicing single sounds or syllables, complete or part words, complete or part phrases as appropriate. Preferably, each speaker has provided at least a minimum selection of samples or undergone a minimum of algorithmic analysis. The algorithmic analysis can take place using any suitable technique for analysis or modelling. Suitable techniques include but are not limited to those incorporating Hidden Markov Modelling or Viterbi processes.

In some embodiments, the message generation engine will be operable to receive message content from the message data engine in a first language and translate the message data into a second language. This can enable the generation of a voiced message in the second language voiced by the intended speaker and corresponding to the meaning of the message content deconstructed in the first language.

If desired or if appropriate, the message generation engine may be operable to incorporate image and/or video data into the message. The image and/or video data may include, but is not limited to, text, captured moving or still images, cartoons or animation. The image and/or video data may be selected from stored or uploaded image and/or video data. Such data may be uploaded by a requestor from a suitable input device. If the image and/or video data is uploaded, this may be achieved by use of the interface. In such embodiments, the inference engine may also be operable to analyse the image and/or video data. This can potentially detect visual libel, offensive gestures or actions likely to cause distress to the recipient contained within the image and/or video data.

According to a second aspect of the present invention there is provided a method for generating a message, the method comprising: making a message request, the message request identifying the intended recipient of said message, the intended speaker of said message and the message content; analysing and deconstructing the message content into its constituent parts; and generating a voiced message from the deconstructed message content by retrieving corresponding speech data from the intended speaker.

The method of the second aspect of the present invention may incorporate any or all aspects of the system of the first aspect of the present invention as desired or as are appropriate.

In order that the present invention is more clearly understood, one embodiment will be described below in detail, by way of example only and with reference to the accompanying drawings in which:—

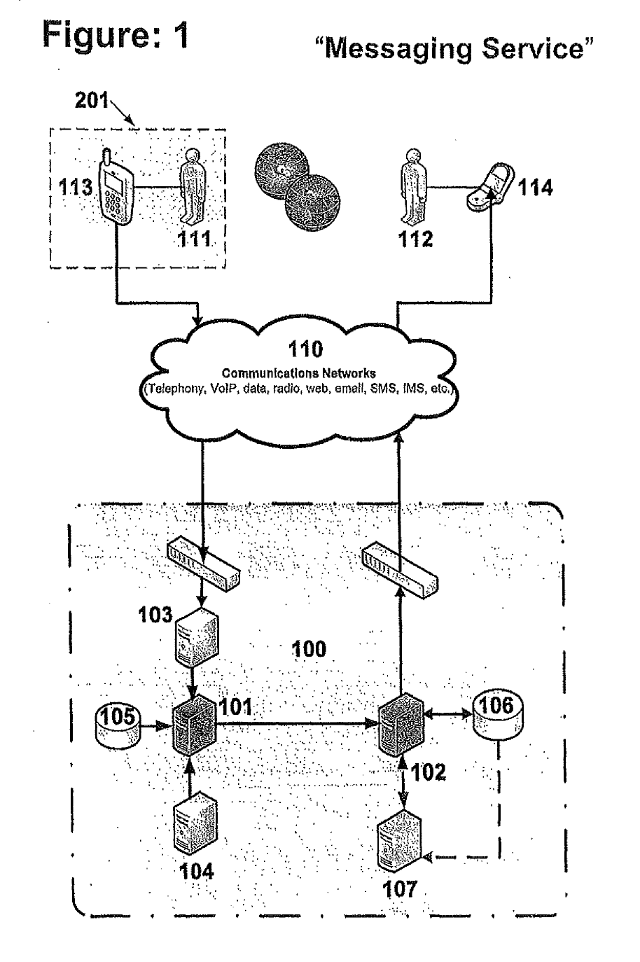

FIG. 1 is a schematic block diagram of one possible embodiment of the implementation of a system according to the present invention; and

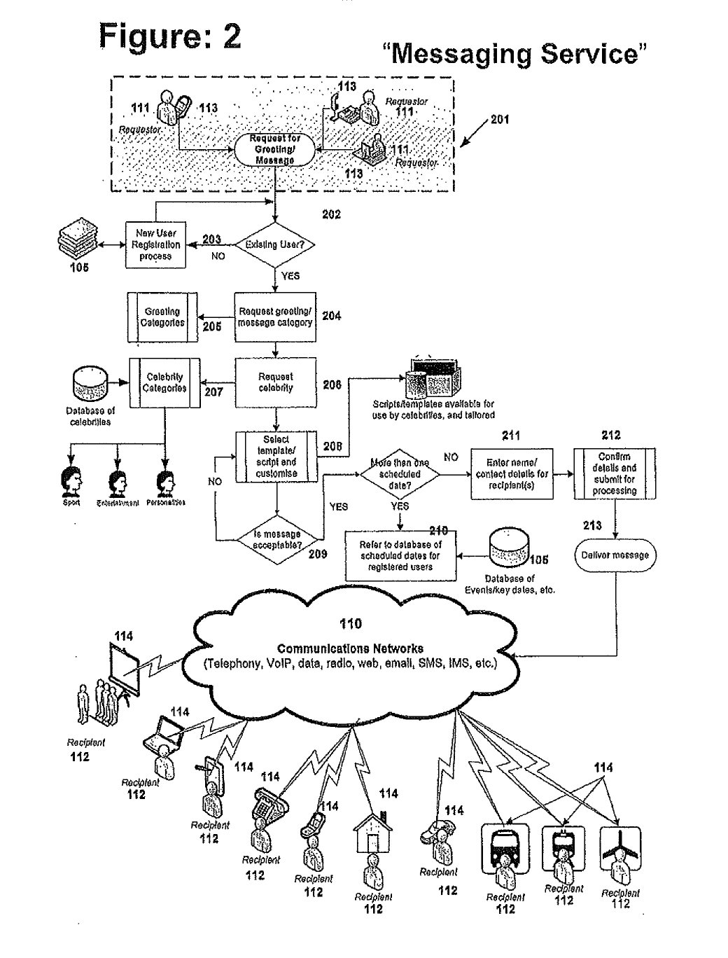

FIG. 2 is a schematic illustration of the operation of a messaging system according to the present invention.

Referring now to FIG. 1, a messaging system 100 is shown connected to one or more communication networks 110 by means of which a requestor 111 may send a personalised message to a desired recipient 112. The requestor uses a suitable device 113 connected to the network 110 to connect with the messaging system 100. Similarly, the recipient 112 has a suitable device 114 connected to the network 110. Whilst for the sake of simplicity a single communications network is shown in FIG. 1, it should be immediately apparent to the skilled man that the system may be connected to a plurality of different networks 110 and that the requestor 111 and recipient 112 need not be connected to the same network 110.

The messaging system 100 comprises a message data engine 101, a message generation engine 102, and an inference analysis engine 107. The message data engine 101 is operable to identify the desired recipient of the message, analyse and deconstruct the desired message content into syllables, words or phrases as desired or as appropriate. The message or part message may then be passed to the inference engine 107 for review of the message content and context. The message may then be referred back to the requester 111 through the interface 103 with details of the problem for remediation, or passed to the message generation engine 102 for transcription. The message generation engine 102 may apply a range of speech samples and/or speech parameters as appropriate to the input message in order to compile a representation of this message with the speaker characteristics that were requested. The message generation engine 102 is then further operable to despatch the generated message to the desired recipient's device 114 via the network 110.

In the example shown, the requester 111 connects with an interface 103 of message data engine 101. The interface 103 enables the requester to readily identify themselves and the desired recipient 112 and further enables them to input the desired message content in a convenient form. The interface 103 may also provide means for selecting other optional features of the message. The interface 103 may of course be an integral part of the message data engine 101 or provided separately, as required or as desire.

Typically, the interface 103 may present differently depending upon the requester's device 113 and/or the nature of the network 110. If the device 113 is a basic telephone, the interface may present as an audible series of instructions and/or options. The requester 111 may choose between options and/or enter data either by speaking or by pressing keys on the telephone keypad. If the device 113 is a computer, suitably enabled telephone or other such device, the interface 103 may present with one or more displayable windows into which data can be input by the requester 111. In particular, the interface 103 may be provided as a downloadable software object or app for a smartphone.

The message data engine may additionally be provided with a database of registered users 105. The database 105 can be updated when a new requester desires to use the system 100 and may allow a known requester 111 to more rapidly identify themselves. The message data engine 101 may further be connected to a payment system 104. The payment system 104 may be operable in response to the message data engine 101 to deduct credit from a requester account with the system 100 or alternatively from an external financial services facility such as a bank or other authorised payment scheme or network providers account. As with the interface 103, the database 105 and payment system 104 may be integral parts of the message data engine 101 or may be provided separately, as required or as desired.

The message generation engine 102 receives message recipient and message content data from the message data engine 101 (via inference engine 107 if appropriate). The message generation engine 102 is then operable to generate a message by combining together speech samples and/or applying speech parameters corresponding to the message content data. The speech samples are retrieved from a speech sample library 106 which may be integral to the message generation engine 102 or provided separately as required or as desired. The speech parameters are retrieved from a speech parameter library 106 which may be integral to the message generation engine 102 or provided separately as required or as desired. The speech samples may comprise speech samples from a number of different speakers, the speakers typically being celebrities or personalities. The speech parameters may be obtained by algorithmic analysis of the speech of a number of different speakers, the speakers typically being celebrities or personalities. By applying the parameters obtained by algorithmic analysis to pre-existing speech samples or neutral speech samples new message content may be generated. The desired celebrity or personality speaker may be selected by the requester 111. In this manner, the message generation engine 102 may generate a message having personalised content voiced by any one of the available celebrities or personalities. It may also be possible for the message generation engine 102 to incorporate additional audio and/or visual content into the message if desired or if appropriate.

The message is delivered via the network 110 and the specified device to the recipient 112. Delivery can be by way of playing or streaming the message over network 110 or alternatively may involve transmitting a file containing the message over the network or transmitting information regarding a location from which the message may be played/streamed or downloaded over the network 110. Typically, if the message is to be transmitted or downloaded, it is in a format compatible with standard multimedia messaging services.

Turning now to FIG. 2, one possible means of operating the messaging system 100 of the present invention is illustrated. The illustration of FIG. 2 is directed to the provision of personalised recorded greeting messages by celebrities or personalities. It is of course possible for the system 100 to be operated to implement other messaging services.

In the operation of the celebrity greeting service of FIG. 2, at step 201 a requestor 111 connects to the interface 103 via a suitable device such as a mobile telephone, fixed line telephone, computer or similar. The requestor 111 can then provide information to the interface or make selections by speaking/pressing keypad controls (in the case of a basic telephone or similar) or by directly inputting data (in the case of a more advanced telephone, computer or similar).

At step 202 the requester 111 is interrogated to determine whether they are an existing user of system 110. If not, they are subject to a registration process. The registration process may involve such steps as: providing name and address details; selecting a unique username and password for future use; providing billing details; providing standard messaging option data; or similar. It is of course possible that a user may choose to further update such details or include additional optional details over time. User details are stored in the database 105.

Once the requestor 111 is identified, the requester 111 is requested to select a message category (e.g. birthday greeting, engagement/wedding greeting, exam success greeting, or general message) at step 204. The requester 111 optionally may be presented with a list of available categories at step 205. The categories may be used to define the context of the message for the inference engine 107.

After the message category is selected, the requester 111 is requested to select a celebrity at step 206. For their benefit, the requester 111 optionally may be presented with a list of available celebrities or categories of available celebrities at step 207.

The requester 111 is then required to provide a script for the message at step 208. This can be based on a template, inserting the recipient's name or may be based on a bespoke text created by the requester 111. A template can be selected from a list of options presented to the requester 111. A bespoke text can be created by speaking (in the case of a basic telephone or similar) or by directly inputting text (in the ease of a more advanced telephone, computer or similar). In the case of a bespoke text, the message data engine 101 analyses and breaks down the message text into syllables, words or phrases as appropriate or by use of various algorithms, either via voice recognition systems (for spoken entry) or by direct recognition of the input text.

The message is then analysed at step 209 by the inference engine 107. The inference engine is operable to determine using various linguistic techniques whether the message could be defamatory or offensive. The inference engine 107 can also optionally analyse grammar and clarity within a message. If the message is determined by the inference engine 107 to be defamatory or offensive, or in optional embodiments to be deficient in grammar or clarity, the message is referred back to the requester at step 208 for editing. The referral may include a highlighting or other indication of the word or phrase of concern for the requestor to edit. If the message, either initially or after referral, passes analysis it is passed to step 210.

In some circumstances, the requestor may not wish to edit the message in relation to the word or phrase of concern. In such circumstances the subsequent messaging steps may be blocked. Alternatively, the requester may be presented with a warning as to the content of concern, the warning providing the requester with the option to proceed with the messaging steps only after declaring responsibility for the message content. The declaration of responsibility may take the form of checkbox on a visual display or may take the form of an additional message to the system operator incorporating specified content. The system can store the declaration and/or data relating to the declaration for a predetermined period. This can provide an audit trail, which may be desirable or may be required in some jurisdictions.

At step 210, the requester 111 is requested to select a scheduled date for delivery of the message. This may be immediate, or may be delayed until a specified time. This can allow a requester 111 to set up the delivery of say a birthday greeting message at a convenient time in advance of the recipient's birthday. If the requester 111 is an existing user, they may have taken the opportunity to store a number of regular dates (e.g. family birthdays) in database 105. In such circumstances, this may allow the requester 111 to select one of the stored dates as a scheduled delivery date at step 210. Optionally, the requester 111 may select that a message or a particular message be delivered at regular intervals or on particular dates in each year.

At step 211, the requestor is required to provide the contact details for the recipient 112. Subsequently, the requestor 111 is required to confirm the details at step 212. The message is generated using message generation engine 102 and subequently delivered (at the scheduled time) at step 213 via a suitable network 110. The contact details may specify or imply a particular mode of delivery. For instance, if the contact provided is a telephone number, the message is delivered via an appropriate telephone network. If the contact is an email address, the message may be delivered as an audio file attached to an email or as an embedded link to a location where the message can be downloaded. The recipient 112 may then receive the message via the contact device specified at the scheduled delivery time.

It is of course to be understood that the invention is not limited to the details of the above embodiment which is described by way of example only.

1-46. (canceled)

47. A messaging system comprising: a message data engine operable to receive an incoming message request, identify the intended recipient of said message, identify the intended speaker of said message, analyse and deconstruct the message content into its constituent parts; a message generation engine operable to generate a voiced message from the deconstructed message content by retrieving corresponding speech data relating to the intended speaker; and an inference engine connected to the message data engine and operable to analyse deconstructed message content, in whole or in part, and thereby whether to refer the message request back to the requestor or pass the message content on to the message generation engine.

48. A messaging system as claimed in claim 47 wherein incoming message requests are received directly at an input device and/or are received via a connection to a suitable communication network and/or the messaging system delivers generated messages directly to an output device and/or generated messages are output to a suitable communication network for delivery.

49. A messaging system as claimed in claim 47 wherein the message data engine is connected to a suitable payment system, in order that payment is obtained from the requestor for delivering and/or generating the message.

50. A messaging system as claimed in claim 47 wherein messaging system is operable to present an interface to enable recipient identity details, intended speaker details (e.g. a celebrity or personality) and message content to be input separately.

51. A messaging system as claimed in claim 47 wherein the message content may be input by selecting an existing message template, editing an existing message template or by creating a bespoke message.

52. A messaging system as claimed in claim 47 wherein in the case of a bespoke message or the editing of an existing template, the message data engine is operable to deconstruct spoken content or is operable to deconstruct text based content into single sounds or syllables, complete or part words, complete or part phrases.

53. A messaging system as claimed in claim 47 wherein the inference engine is operable to analyse the message content and context and thereby determine whether the message is potentially defamatory or offensive.

54. A messaging system as claimed in claim 53 wherein the inference engine is additionally operable to analyse the message grammar and clarity.

55. A messaging system as claimed in claim 47 wherein referral to the requestor includes a highlighting or other indication of the word or phrase of concern for the requestor to edit.

56. A messaging system as claimed in claim 55 wherein if the requestor does not edit the message in relation to the word or phrase of concern, the subsequent messaging steps are blocked.

57. A messaging system as claimed in claim 55 wherein the if the requestor does not edit the message in relation to the word or phrase of concern, the requestor is presented with the option to proceed with the messaging steps only after declaring responsibility for the message content.

58. A messaging system as claimed in claim 11 wherein the system is operable to store the declaration and/or data relating to the declaration for a predetermined period.

59. A messaging system as claimed in claim 47 wherein the message is: played or streamed over a suitable network or link, delivered in the form of a file for playback by the output device, or delivered in the form of a link to a location from where the message can be played, streamed or downloaded for later playback and wherein the format of the delivered message is dictated by the recipient address and/or the recipient's output device.

60. A messaging system as claimed in any preceding claim wherein the speech data comprises speech samples and/or speech parameters.

61. A messaging system as claimed in claim 60 wherein the speech parameters include any one or more of: cadence, tone, excitation, inflexion, spectral characteristics, phonetic characteristics, linguistic characteristics, sound/pause duration.

62. A messaging system as claimed in claim 60 wherein the message is generated by retrieving and combining together one or more speech samples of the intended speaker.

63. A messaging system as claimed in claim 62 wherein the message is generated in whole or in part by applying speech parameters to pre-existing speech samples.

64. A messaging system as claimed in claim 47 wherein the message generation engine is operable to receive message content from the message data engine in a first language and translate the message data into a second language.

65. A messaging system as claimed in claim 47 wherein the message generation engine is operable to incorporate image and/or video data into the message and wherein the inference engine is operable to analyse the image and/or video data.

66. A method for generating a message, the method comprising: making a message request, the message request identifying the intended recipient of said message, the intended speaker of said message and the message content; analysing and deconstructing the message content into its constituent parts; and generating a voiced message from the deconstructed message content by retrieving corresponding speech data from the intended speaker wherein before generating a voiced message, the deconstructed message content is analysed, in whole or in part, to thereby determine whether to refer the message request back to the requestor or pass the message content on to generate a voiced message.
